(19) United States
(12) Patent Application Publication
(10) Pub. No.: US 2010/0272472 A1
(43) Pub. Date: Oct. 28, 2010

(54) IMAGE FORMING APPARATUS AND IMAGE FORMING METHOD

(75) Inventors: Katsuhito GOMI, Chino-shi (JP); Kenjiro YOSHIOKA, Shiojiri-shi (JP); Yoshiyuki NAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/764,229

(22) Filed: Apr. 21, 2010

(30) Foreign Application Priority Data
Apr. 22, 2009 (JP) 2009-103668

(51) Int. Cl. G03G 15/10; G03G 15/16; G03G 15/00

(52) U.S. Cl. 399/237; 399/400; 399/304

(57) ABSTRACT

An image forming apparatus including a developing portion for developing a image carrier with liquid developer including a toner and a carrier liquid, a transfer portion for transferring the image developed on the image carrier in the developing portion onto a surface of the recording medium, and a recording medium transporting portion for transporting the recording medium onto which the image has been transferred with surface of the recording medium onto which the image has been transferred facing downward, with the upward facing surface being sucked and held by air flow.

### BACKGROUND OF THE INVENTION

The entire disclosure of Japanese Patent Application No. 2009-103668, filed Apr. 22, 2009 is expressly incorporated herein by reference.

1. Technical Field

The present invention relates to an image forming apparatus and an image forming method of an electrophotography type. More specifically, the present invention relates to an image forming apparatus and method in which a recording medium is transported by a recording medium transporting portion with the recording medium being sucked and held after an electrophotographic image has been transferred thereon.

2. Related Art

One example of an image forming apparatus of the electrophotography type that is currently known in the art is found in Japanese Patent Document No. JP-A-6-135613, which discloses an image forming apparatus in which a recording medium such as a sheet of paper is transported to a fixing portion with the recording medium being sucked and held by a recording medium transporting belt having a plurality of sucking holes. In the image forming apparatus, the recording medium is sucked and transported using the transporting belt to the fixing portion, causing the recording medium to be transported as desired.

In the image forming apparatus as described in JP-A-6-135613, the recording medium transporting belt transports the recording medium with the surface on which an transferred image faces upward, the recording medium being sucked and held by air flow which is moving vertically downward. However, in such a recording medium transporting portion, the recording medium transporting belt is arranged in a horizontal direction with respect to the image transfer portion. Therefore, a large space is required in the horizontal direction for accommodating the recording medium transporting portion. In particular, when image forming units of four colors arranged in tandem manner as shown in FIG. 5, the space required in the horizontal direction, i.e., in the recording medium transporting direction, becomes even larger under the condition where the recording medium transporting belt is arranged in a horizontal direction with respect to a second transfer portion.

In order to reduce the horizontal size of the apparatus, attempts have been made to arrange the recording medium transporting portion vertically with respect to the image forming unit to reduce the horizontal space. One difficulty with this configuration, however, is that if the horizontal space needs to be small for the installment of the recording medium transporting portion transporting belt with the image transferred surface facing upwards, the recording medium transporting portion must be located vertically below the image forming unit in consideration of transfer operation for a recording medium transported through a transporting path, as shown in FIG. 6. For this reason, the fixing portion is to be positioned vertically below the image forming unit. One problem with this configuration, however, is that if the fixing portion is positioned vertically below the image forming unit, it is likely that the toner in the image forming unit will coagulate due to the heat of the fixing portion.

Additionally, if the recording medium transporting belt is positioned vertically above the recording medium, the recording medium is not stably sucked to the recording medium transporting belt due to gravity and it is likely that there will be a failure to transport the recording medium as desired.

### BRIEF SUMMARY OF THE INVENTION

An advantage of some aspects of the invention is that it provides an image forming apparatus which is compact and which has a recording medium transporting belt that transports a recording medium as desired while inhibiting the coagulation of the toner in the image forming unit.

Another advantage of some other aspects of the invention is that it provides an image forming method which enables an image forming apparatus to be compact and to transport a recording medium as desired without occurrence of coagulation of the toner in the image forming unit.

According to an aspect of the invention, in an image forming apparatus and an image forming method, an image developed by liquid developer containing toner and carrier liquid is transferred to a recording medium at a transferring portion. At that time, the carrier liquid contained in the toner image permeates to a coat layer and fibrous layer. Consequently, in the recording medium to which the carrier liquid has permeated, spaces of the coat layer and fibrous layer are filled with the carrier liquid so that a ventilation property of the recording medium deteriorates thereby increasing the sucking and holding force. In addition, the recording medium transporting portion may be configured such that the recording medium is transported while it is sucked and held vertically upwards by the air flow over the surface opposite the image transferring surface with the image transfer surface facing downward. With this structure, even if the recording medium transporting portion is located above the image forming unit and directly above the recording medium, the recording medium is not likely to drop downwards, so stable transportation of the recording medium is enabled. In addition, as the recording medium transporting portion is located above the image forming unit, it is possible that coagulation and concretion of the toner in the image forming unit is prevented.

In another aspect of the invention, as non-volatile oil (non-volatile carrier liquid) is used for the carrier liquid of the liquid developing agent, the carrier liquid permeated to the coat layer and fibrous layer is held in those layers without volatilizing. With this structure, the sucking and holding force for transporting the recording medium is further improved, thereby enabling stable transportation of the recording medium.

### BRIEF DESCRIPTION OF THE DRAWINGS

The invention will be described with reference to the accompanying drawings, wherein like numbers reference like elements.

FIG. 1 is a partial schematic view which illustrates an image forming apparatus according to an embodiment of the invention;

FIG. 2A is a partial perspective view of a secondary transferring portion of the image forming apparatus shown in FIG. 1;

FIG. 2B is an enlarged view of an IIB portion of the portion shown in FIG. 2A;

FIG. 2C is a partial right side view of the apparatus shown in FIG. 2A;

FIG. 3 is a drawing illustrating the removal of a recording medium from a secondary transfer roller after transference of an image onto the recording medium;

FIG. 4 is a schematic illustration of the configuration of the secondary transfer portion to a fixing portion shown in FIG. 1;

FIG. 5 is a schematic illustration of an example of an image forming apparatus currently known in the art;

FIG. 6 is a schematic illustration of another example of an image forming apparatus which is currently known in the art.

### DESCRIPTION OF EXEMPLARY EMBODIMENTS

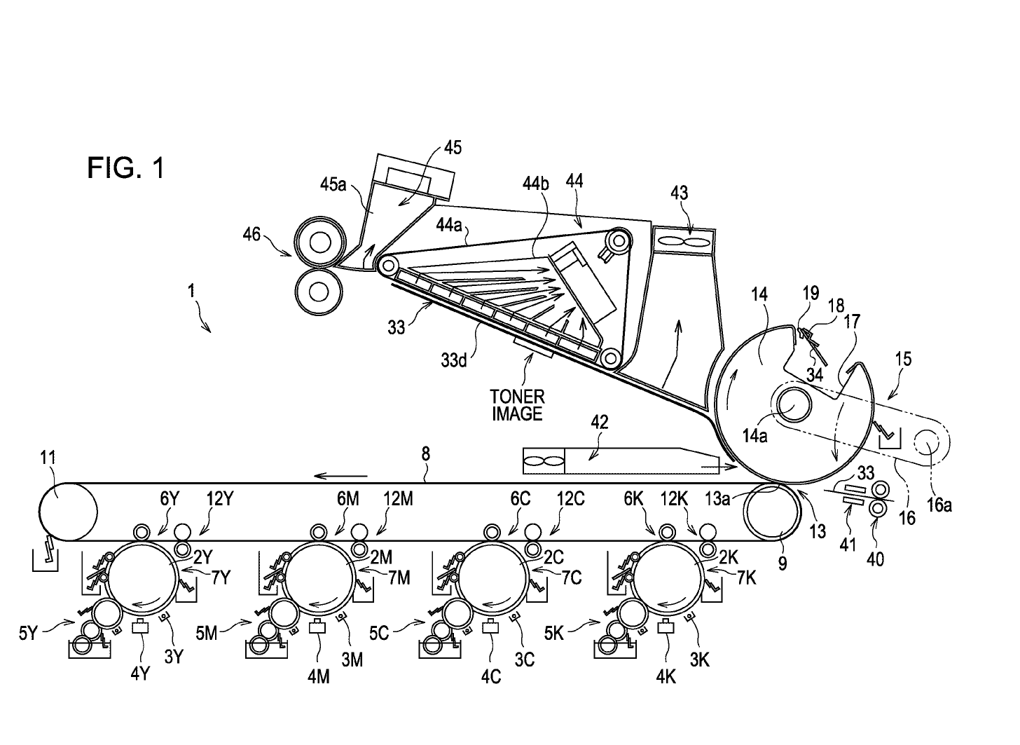

An embodiment of the invention will be described hereinafter with reference to the accompanying drawings. FIG. 1 is a partial schematic which illustrates an image forming apparatus according to an embodiment of the invention.

The image forming apparatus 1 of the embodiment is designed to form an image using liquid developer containing toner particles and a carrier liquid. The liquid developer may have a composition in which toner particles including resin and pigments having an average particle size of about 0.1-5 μm are dispersed at a high density such as about 5-40 wt % in nonvolatile and insulating carrier liquid such as silicone oil. Mineral oil or plant oil may be used as the carrier liquid in lieu of the silicone oil.

As shown in FIG. 1, the image forming apparatus 1 is provided with photosensitive members 2Y, 2M, 2C and 2K arranged in series horizontally or approximately horizontally, which act as image carriers of yellow (Y), magenta (M), cyan (C), and black (K). The photosensitive members 2Y, 2M, 2C and 2K, include a yellow photosensitive member 2Y, magenta photosensitive member 2M, a cyan photosensitive member 2C, and a black photosensitive member 2K. In the same way, the letters Y, M, C and K are respectively used with other members to indicate that the members are associated with the above mentioned colors.

Charging portions 3Y, 3M, 3C and 3K are respectively arranged around the photosensitive members 2Y, 2M, 2C and 2K. In rotational directions of the photosensitive members 2Y, 2M, 2C and 2K, exposure portions 4Y, 4M, 4C and 4K, developing portions 5Y, 5M, 5C and 5K, primary transferring portions 6Y, 6M, 6C and 6K, and photosensitive member cleaning portions 7Y, 7M, 7C and 7K are arranged in the described order. An image forming unit 1 of the exemplary embodiment is composed of the exposure portions 4Y, 4M, 4C and 4K, developing portions 5Y, 5M, 5C and 5K, primary transferring portions 6Y, 6M, 6C and 6K, and photosensitive member cleaning portions 7Y, 7M, 7C and 7K.

The image forming apparatus 1 is provided with an endless intermediate transfer belt 8, which acts as an image carrier. The intermediate transfer belt 8 is arranged above the photosensitive members 2Y, 2M, 2C and 2K. The intermediate transfer belt 8 is pressed against each photosensitive member 2Y, 2M, 2C and 2K at respective primary transfer portions 6Y, 6M, 6C and 6K.

The intermediate transfer medium 8 is a comparatively soft elastic belt having a three layer structure composed of a flexible substrate of resin or the like, an elastic layer of rubber or the like formed on the surface of the substrate and a top layer (not shown). Needless to say that the intermediate transfer belt 8 is not restricted to this particular structure or material and that variations may be made without departing from the meaning and scope of the invention. The intermediate transfer belt 8 is wound around an intermediate transfer belt tension roller 11 and an intermediate transfer belt driving roller 9 to which a driving force from a motor (not shown) is transmitted. The intermediate transfer belt 8 is arranged to turn in the direction shown by the arrow shown in the drawing with the intermediate transfer belt receiving tension. Note that the order of arrangement of the members such as the photosensitive members respectively associated with the colors Y, M, C and K is not restricted to that shown in FIG. 1 but may be set arbitrarily.

Intermediate transfer belt squeeze devices 12Y, 12M, 12C and 12K are respectively arranged at positions along the intermediate transfer belt 8 in the vicinity of respective primary transfer portions 6Y, 6M, 6C and 6K. The intermediate transfer belt squeeze device 12Y, 12M, 12C, and 12K are advanced in the direction in which the intermediate transfer belt turns from the respective primary transfer portions. In addition thereto, a secondary transfer portion 13 serving as a transfer device is installed on the side of intermediate transfer belt driving roller 9 for the intermediate transfer belt 8.

The secondary transfer portion 13 is provided with a secondary transfer roller 14 and a secondary transfer roller cleaning portion 15. Both end portions 14a of a rotational shaft of the secondary transfer roller 14 are rotatably supported by a pair of secondary transfer roller supporting frames 16. The secondary transfer roller supporting frames 16 swing about a rotary shaft 16a (rotational fulcrum) which is supported by a main body of the image forming apparatus (not shown) and which is urged by an urging means such as a spring (not shown) in the direction shown by an arrow shown in the secondary transfer roller 14. The pressing force of the urging means urges the secondary transfer roller 14 against the intermediate transfer belt 8. At that time, the intermediate transfer belt driving roller 9 functions as a back-up roller against the pressing of the secondary transfer roller 14.

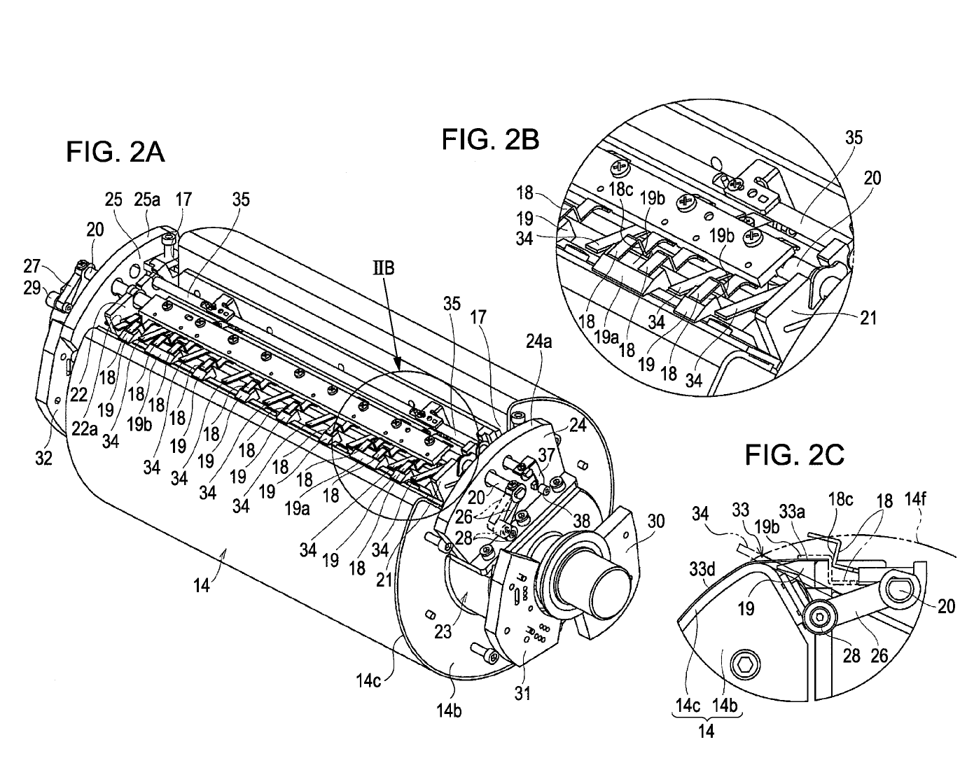

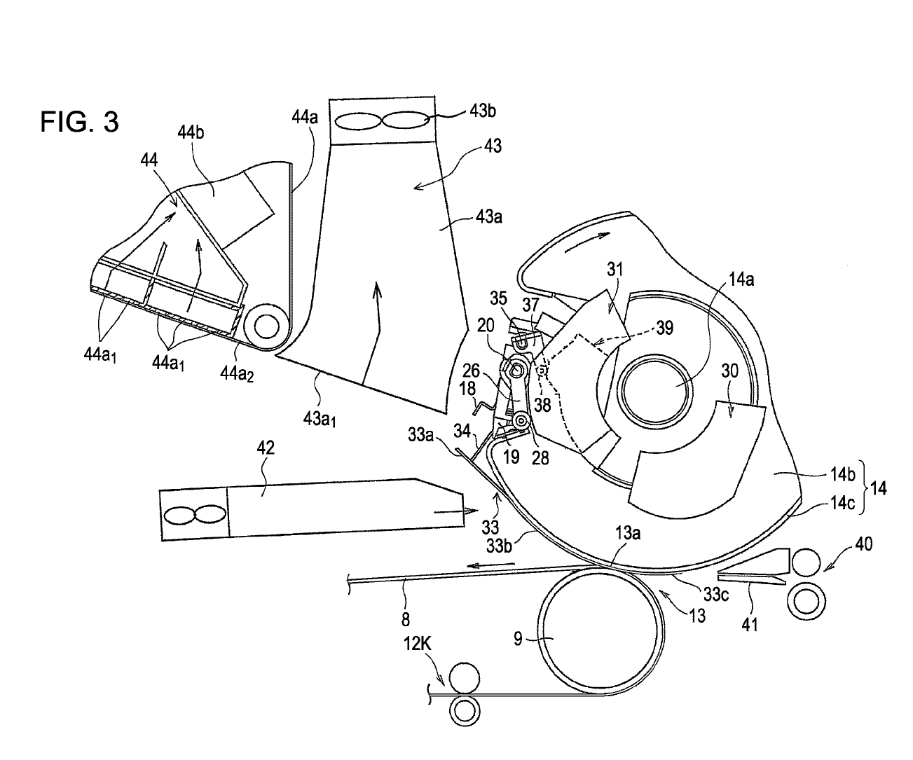

Further, the secondary transfer roller 14 is formed with a recess 17. As shown in FIG. 2A, the recess 17 extends in an axial direction of the secondary transfer roller 14. The secondary transfer roller 14 has a sheet-shape elastic member 14c wound around the outer circumference of the substrate 14b. The elastic member 14c serves as a frictional layer. As shown in FIG. 1 and FIG. 3, a secondary transfer nipping point 13a is formed between the intermediate transfer belt 8 and the elastic member 14c of the intermediate transfer roller 14.

A transfer bias is applied to the secondary transfer roller 14 in order to transfer a toner image from the intermediate transfer belt 8 to the recording medium such as an image transfer sheet of paper. When the intermediate transfer belt 8 turns in the direction shown by the arrow, the secondary transfer roller 14 turns in the second direction as shown by the arrow and receives the transfer bias to transfer the toner image on the intermediate transfer belt 8 to the recording medium at the secondary transfer nipping point 13a.

A gripper 18 serving as a recording medium gripping member is disposed in the recess 17 along with a gripper supporting portion 19 serving as a recording medium gripping portion receiving member on which the gripper 18 sits. As shown in FIGS. 2A and 2B, ten grippers 18 are arranged along the axial direction (first direction) of the secondary transfer roller 14. Needless to say that the number of the grippers is not limited to ten, but may be determined arbitrarily. Each gripper is formed by bending a thin metal strip in two places so as to form portions of the same size and so as to have a crank shape.

Each gripper 18 is arranged on the rotary shaft 20 to rotate integrally with the rotary shaft 20. Both end portions of the rotary shaft 20 are rotatably supported by supporting plates 21 and 22 which are arranged at positions opposing the recess 17 of the secondary transfer roller 14.

The first gripper controlling cam follower 28 is installed on one end of the rotary shaft 20 by way of the first arm 26. A second gripper control cam follower 29 is installed on the other end of the rotary shaft 20 by way of the second arm 27. When the secondary transfer roller 14 rotates, the first gripper control cam follower 28 is controlled by the first and third gripper control cams 30 and 31. When the secondary transfer roller 14 rotates, the second gripper control cam follower 29 is controlled by a second gripper control cam (not shown) which is same as the first gripper control cam 30 and a fourth gripper control cam 32 which is the same as the third gripper control cam 31. The first and second gripper control cam followers 28 and 29 are controlled in synchronization with each other.

As shown in FIG. 2A, eight gripper supporting portions 19 are arranged in an axial direction of the secondary transfer roller 14. Note that the number of the gripper supporting portions is not limited to eight, but any number corresponding to the number of the grippers 18 may be employed.

Of the eight gripper supporting portions 19, two gripper supporting portions 19a positioned at both ends of the secondary transfer roller 14 are longer in the axial direction than the other gripper supporting portions 19. With this arrangement, the gripper supporting portions 19a can cope with the size of the recording medium 33 in the axial direction of the secondary transfer roller 14.

As shown in FIGS. 2B and 2C, the gripper supporting portions 19 and 19a are provided with gripper abutting portions 19b with which the grippers 18 come into abutment with. The gripper 18 corresponding to the gripper abutting portions 19b of the gripper supporting portions 19 and 19a come into abutment with the gripper supporting portions 19 and 19a and detach therefrom. The abutment and detachment of the grippers 18 with or from the gripper supporting portions 19 and 19a are controlled by the first and second gripper control cam followers 28 and 29.

That is, as shown in FIG. 2C, when the front end 33a of the recording medium 33, which is supplied from the gate roller 40 via a recording medium supply guide 41, comes into abutment with stepped portions 18c of the grippers 18, which are under control of the first and second cam followers, the grippers 18 hold the front end 33a between the grippers 18 and the gripper abutting portions 19b of the gripper supporting portions 19 and 19a in a recording medium holding step. The holding of the recording medium 33 is carried out just before the recess 17 reaches a position corresponding to the secondary transfer nipping point. Thus, a recording medium holding portion is composed of the grippers 18 and the gripper supporting portions 19 and 19a.

After the grippers 18 hold the recording medium 33, the recording medium 33 successively comes into abutment with an outer circumference of the secondary transfer roller 14 in an area towards its rear end 33c. Further, under control of the first and second gripper control cam followers 28 and 29, the grippers 18 leave the gripper supporting portion 19 to release the front end 33a of the recording medium 33 after the recess 17 passes the position corresponding to the secondary transfer nipping point.

When the recess 17 reaches a position where it opposes the intermediate transfer belt driving roller 9, the recess 17 of the secondary transfer roller 14 does not abut against the intermediate transfer belt 8. Accordingly, a secondary transfer nipping point 13a is not formed between the intermediate transfer belt 8 and secondary transfer roller 14. Therefore, the position of the secondary transfer nipping point 13a is defined as the position at which the secondary transfer roller 14 is pressed against the intermediate transfer belt 8 with the widths of the secondary transfer roller 14 and intermediate transfer belt 8 in their rotational direction being maximized.

The rotation of the secondary transfer roller 14 at the time when the recording medium 33 is held, has a vector component with the same direction as that of the movement of the recording medium 33 which is supplied from the gate roller 40. Accordingly, while the grippers 18 are apart from the gripper supporting portions 19, the front end portion 33a of the recording medium 33 moves as if following the moving grippers 18, and moves between the grippers 18 and gripper supporting portion 19. After that, the grippers 18 press the front end 33a of the recording medium 33 against the gripper supporting portions 19 so that the recording medium 33 is held.

When the holding portion at the distal end of the grippers 18 holds the front end portion 33a of the recording medium 33 between the grippers 18 and the gripper supporting portions 19 as shown by the phantom line in FIG. 2C, all of the grippers 18 are retracted to the inside of an imaginary contour line 14f of the elastic member 14c of the secondary transfer roller 14. When the grippers 18 are in the release position as shown by a solid line in FIG. 2C, the holding portion at the front end side of the grippers 18 projects to the outer side of the imaginary contour line 14f.

The toner image on the intermediate transfer belt 8 is transferred to the recording medium 33 at the secondary transfer nipping point 13a while the front end portion 33a of the recording medium 33 is held by the grippers 18 in the transfer step. A circumference of the secondary transfer roller 14 in the area where the recess 17 is not formed in the rotational direction of the secondary transfer roller 14 is set to be larger than a length of a recording medium having the largest length in the moving direction among the plurality of recording media to be used in the image forming apparatus 1 of the exemplary embodiment. With this setting, the toner image on the intermediate transfer belt 8 is reliably transferred to the recording medium 33 of the maximum length.

When the front end portion 33a of the recording medium 33 held by each gripper 18 passes the secondary transfer nipping point 13a, each gripper 18 begins to move in the direction in which each gripper 18 separates from the gripper supporting portion 19 and the front end portion 33a of the recording medium 33 is released.

Additionally, protruding claws 34 as recording medium peeling members are disposed within the recess 17. As shown in FIGS. 2A and 2B, nine protruding claws 34 are arranged along the axial direction of the secondary transfer roller 14. Needless to say that the number of the protruding claws 34 is not limited to nine but may be any number. The protruding claws 34 are each formed from a thin metal strip so as to have the same shape and the same size. The protruding claws 34 each performs rectilinear motion integrally with each other guided by a rectilinear guide hole formed on the supporting plates 21 and 22. On the other hand, a rotary shaft 35 is rotatably supported by the supporting plates 21 and 22. The rotation of the rotary shaft 35 is converted into the rectilinear motion of each protruding claw 34 by a motion converting mechanism (not shown) which is known by those skilled in the art.

Each protruding claw 34 is configured to move rectilinearly between a retracted position as shown by a solid line in FIG. 2C and a protruding position as shown by a phantom line in the same drawing. In that case, all of the protruding claws 34 are positioned on the inner side of an imaginary contour line 14f, i.e., within the recess 17 when the protruding claws are in the retracted position. Conversely, the front ends of the protruding claws 34 protrude outside of the imaginary contour line 14, i.e., outside of the recess 17 when the claws 34 are in the protruding position. Then, the protruding claws 34 do not abut against the back surface of the recording medium 33 when the protruding claws are in the retracted position, while the protruding claws 34 abut against the back surface of the recording medium 33 to push the recording medium 33 out of the outer circumference of the secondary transfer roller 14, i.e., remove the back of the recording medium 33 off of the outer circumference of the secondary transfer roller 14 when the protruding claws 34 are in the protruding position.

As shown in FIGS. 2A and 3, a cam follower 38 that controls the first protruding claw is provided via an arm 37 on one end of a rotary shaft 35 which extends through the supporting plate 21. A cam follower (not shown) that controls a second protruding claw that is similar to the cam follower that controls the first protruding claw, is installed via an arm that is similar to the arm 37, on the other end of the rotary shaft 35 extending through the supporting plate 22. When the secondary transfer roller 14 rotates, the cam follower 38 that controls the first protruding claw is controlled by the first protruding claw control cam 39. Also, when the secondary transfer roller 14 rotates, the second cam follower (not shown) that controls the second protruding claw is controlled by the second protruding claw control cam (not shown). The first and second cam followers that control the protruding claws are controlled synchronously.

As shown in FIG. 3, after the secondary transfer roller 14 rotates and the recess 17 has passed the secondary nipping point corresponding position, each protruding claw 34 moves to be in the protruding position before or after the release of the front end portion 33a of the recording medium 33 by the grippers 18, each protruding claw moves to be in the protruding position and pulls the back of the recording medium 33 off from the outer circumference of the secondary transfer roller 14. When the secondary transfer roller 14 rotates further, each protruding claw 34 moves away from the back of the recording medium 33, and each protruding claw 34 moves to be in the retracted position. Each protruding claw is held in the retracted position until it moves to be in the protruding position before or after the release of the front end portion 33a of the recording medium 33 by the grippers 18 in a similar way at the time that the next image forming operation is performed.

As shown if FIG. 2A, an abutting member supporting portion 23 is installed on one end of the secondary transfer roller 14 to integrally rotate with the secondary transfer roller 14. A first abutting member 24 serving as a first positioning member is placed on the abutting member supporting portion 23. In the same way, the same abutting member supporting portion similar to the abutting member supporting portion 23 is provided on the other end of the secondary transfer roller 14, and a first abutting member 25 serving as the first positioning member is placed on the abutting member supporting portion. The respective first abutting members 24 and 25 rotate integrally with the secondary transfer roller 14. The first abutting members 24 and 25 have circular outer circumferences 24a and 25a which are coaxial with the outer circular circumference of the secondary transfer roller 14.

Although not shown in the drawings, second abutting members serving as second positioning members are respectively provided on a rotary shaft 9a at both ends of the intermediate transfer belt driving roller 9. Then, when the first abutting members 24 and 25 are at positions where they do not oppose respective second abutting members, the elastic member 14c of the secondary transfer roller 14 comes into abutment with the intermediate transfer belt 8 to form a secondary transfer nipping point 13a. In that case, the recess 17 of the secondary transfer roller 14 hardly opposes the secondary transfer nip point position.

When the first abutting members 24 and 25 are at positions where they oppose respective second abutting members, the outer circumferences 24a and 25a of the first abutting members 24 and 25 come into abutment with corresponding second abutting members. At that time, a portion of the recess 17 of the secondary transfer roller 14 opposes the secondary transfer nip point positions as mentioned above. In this way, as the first abutting members 24 and 25 come into abutment with the second abutting member, the secondary transfer roller 14 does not significantly change its position relative to the intermediate transfer belt 8 and the intermediate transfer belt driving roller 9 and its position is maintained even if the recess 17 opposes the secondary transfer nip corresponding position.

The secondary transfer roller cleaning portion 15 is provided with a cleaning member 15a such as cleaning blade or the like, and a liquid developer reclaim container 15b. The cleaning member 15a comes into abutment with the outer circumference of the elastic member 14c of the secondary transfer roller 14 to remove the liquid developer attached to the elastic member 14c. The liquid developer reclaim container 15b reclaims and stores the liquid developer removed by the cleaning member 15a.

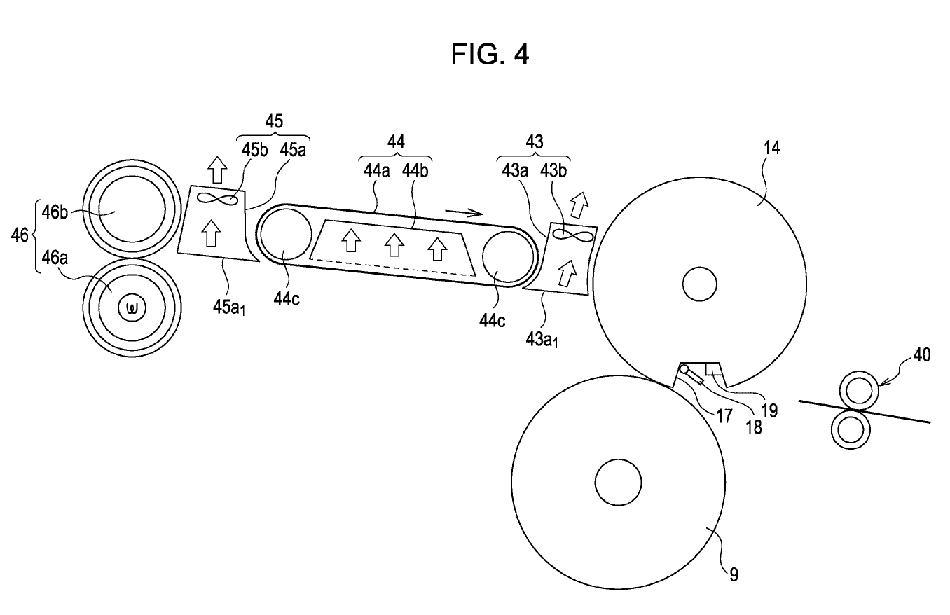

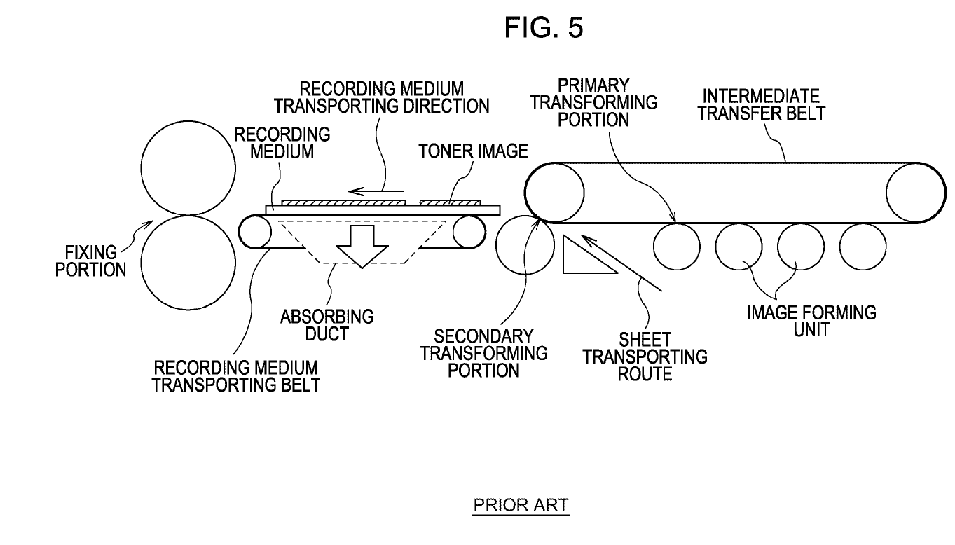

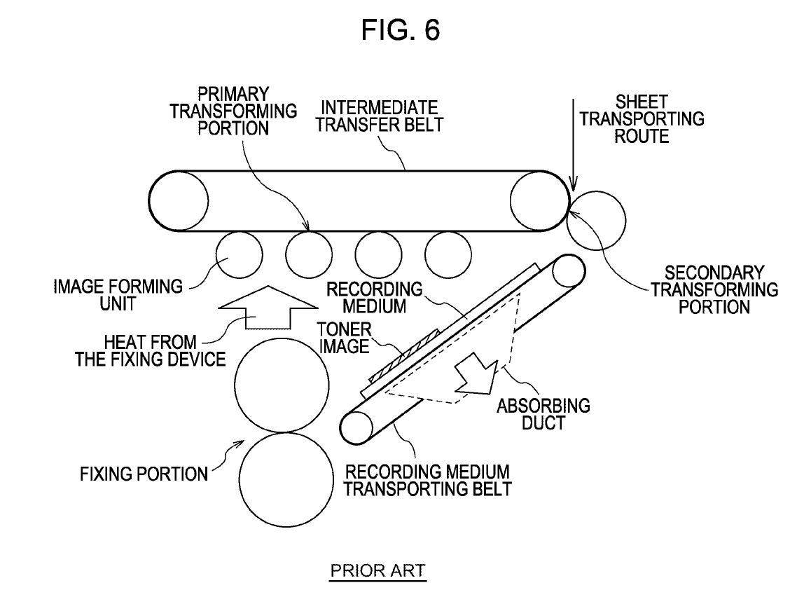

Further, as shown in FIGS. 1 and 4, the image forming apparatus 1 is provided with a first air flow generating device 42, a second air flow generating device 43, a recording medium transporting portion 44, a third air flow generating device 45 and a fixing portion 46. Each of the first air flow generating device 42, the second air flow generating device 43, the recording medium transporting portion 44, the third air flow generating device 45 and the fixing portion 46 are located vertically above the image forming unit and the intermediate transfer belt 8. The first air flow generating device 42 blows air, as indicated by an arrow in FIG. 3, to the front end portion 33a of the recording medium 33 which has been released from the grippers 18. With this, the front end portion 33a of the recording medium 33 is prevented from moving along with the intermediate transfer belt 8.

As shown in FIGS. 3 and 4, the second air flow generating device 43 is provided with an inhaling member 43a which has a guide plane 43a₁, and an air flow generator 43b which inhales air. The inhaling member 43a is formed so as to have a box shape with its inner portion being hollow. Although not shown in the drawings, a plurality of elongated inhaling holes are provided at the positions of the guide plane 43a₁ to communicate with the inside and outside of the inhaling member 43a.

The front end 33a of the recording medium 33 which has been peeled off the secondary transfer roller 14, moves to the guide plane 43a₁ of the inhaling member 43a. Then, air is absorbed in the direction shown by the arrow in FIG. 3 through respective air suction holes of the inhaling member 43a by means of the air flow generating member 43b. The recording medium 33 is transported while it is guided by the guide plane 43a₁ and is sucked and held by the inhaling member 43a by means of the air flow of the air suction of the air inhaling member 43a. At that time, an intermediate portion 33b of the recording medium 33 comes into abutment with the guide plane 43a₁ of the air flow generating device 43 while a rear end portion 33c of the recording medium 33 is pinched by the elastic member 14c of the secondary transfer roller 14 and the intermediate transfer belt 8. Accordingly, the recording medium 33 is transported to the recording medium transporting portion 44 by the rotational force of the intermediate transfer belt 8 and the secondary transfer roller 14 while the recording medium 33 is sucked up to the guide plane 43a₁ with a transfer plane 33d on which a toner image has been transferred, facing downward in the vertical direction.

The recording medium transporting portion 44 is provided with a suction member 44b and an endless recording medium transporting belt 44a which turns in the direction shown by the arrow shown in FIGS. 1 and 4. As shown in FIG. 3, the recording medium transporting belt 44a is formed with multiple air suction holes 44a₁. The front end 33a of the recording medium 33 which has been guided and transported from the second air flow generating device 43, moves to the recording medium transport belt 44a of the recording medium transporting portion 44.

As shown in FIGS. 1, 3 and 4, the air suction member 44b sucks air in the direction shown by the arrows via the air suction holes 44a₁ of the recording medium transporting belt 44a. The recording medium 33 is transported by way of its back to the third air flow generating device 45 while it is sucked up and held by the air flow due to the air suction of the suction member 44b in a recording medium transporting step. That is, the recording medium 33 is transported with its image transfer plane 33d facing downward in the vertical direction and the plane opposite the image transfer plane 33d is sucked up and held by air flow to the recording medium transporting belt 44a in a recording medium transporting stage.

Note that the recording medium transporting belt 44a, in FIG. 1, is wound around three winding rollers while FIG. 4 shows that the recording medium transporting belt 44a is wound around two winding rollers 44c. This is for the sake of simplifying the drawing. Although FIG. 4 shows only two winding rollers 44c, the recording medium transporting belt 44a is wound around three winding rollers. As an alternative configuration, the recording medium transporting belt 44a shown in FIG. 1 may be wound around two winding rollers.

As shown in FIGS. 1 and 4, the third air flow generating device 45 is provided with an air flow generating portion 45b and a suction member 45a which has a guide plane 45a₁ for guiding the recording medium 33. The suction member 45a is formed in the shape of a box whose inside is hollow. Although not shown in the drawings, a plurality of elongated suction holes are formed at the position of the guide plane 45a₁ of the suction member 45a to communicate with the outside and inside of the suction member 45a.

The front end portion 33a of the recording medium 33 which has been transported from the recording medium transporting belt 44a, moves to the guide plane 45a₁ of the suction member 45a. Then, the suction member 45b sucks air in the direction indicated by an arrow shown in FIGS. 1 and 4 through the suction holes of the suction member 45a. By means of the air flow of the suction member 45a, the recording medium 33 is sucked up and guided to the guide plane 45a₁ of the suction member 45a with the image transfer plane 33d facing downwards in the vertical direction, and is guided to the fixing portion 46 by a transporting force of the recording medium transporting belt 44a.

The fixing portion 46 includes a heating roller 46a and a pressing roller 46b which is pressed against the heating roller 46a. Thus, the toner image on the recording medium 33 is pressed and heated by the heating roller 46a and pressing roller 46b and thereby fixed in a fixing step. After that the recording medium 33 is ejected onto an ejection tray (not shown).

According to an aspect of the image forming apparatus 1 of the above described exemplary embodiment, the image developed by a liquid developer including toner and carrier, is transferred to the recording medium 33 at the secondary transfer portion 13. At that time, the carrier liquid included in the toner image penetrates into the coat layer and fiber layer of the recording medium 33. Consequently, the recording medium 33 which the carrier liquid has penetrated is filled with the carrier liquid so that its ventilation property decreases and the attracting force of the recording medium transporting belt 44a increases. Moreover, the recording medium 33 is transported by the recording medium transporting belt 44a of the recording medium transport portion 44 with the image transfer plane 33d being sucked and held vertically downward by air flow. Accordingly, the gravitational effect which the recording medium 33 exerts on the recording medium transporting belt 44a, may be reduced. With this operation, even in the case when the recording medium transporting belt 44a is located above the image forming unit, the image transfer medium 33 does not fall in the direction of gravity, thereby enabling stable transportation of the recording medium 33. In addition, because the recording medium transporting belt 44a is located above the image forming unit, it is possible to prevent cohesion or coagulation of the image forming unit due to the heat of the fixing portion 46.

Still further, as nonvolatile carrier liquid is used for the carrier liquid of the liquid developer, the carrier liquid that penetrated the coat layer and the fiber layer of the recording medium 33 is held without volatilizing. With this, sucking and holding force for the recording medium transporting belt 44a of the recording medium transporting portion 44 are improved further, enabling stable transportation of the recording medium 33.

Although general configuration and an image forming operation of the invention is described above, as may be understood by those of skill in the art, variations may be made without departing from the meaning or spirit of the invention.

For example, although the intermediate transfer belt 8 is used for the image carrier in the embodiment, an intermediate transfer drum may be used and a photosensor may be used for the image carrier. When the photosensor is used for the image carrier, the toner image on the photosensor is directly transferred to the recording medium. Although the image forming apparatus of each exemplary embodiment is series type image forming apparatus, the apparatus may be of another type or may be of monochrome type. In short, variations and modifications may be made within the scope described in the claims.

What is claimed is:

1. An image forming apparatus comprising:
a developing portion that develops an image on an image carrier with a liquid developer including a toner and a carrier liquid;
a transfer portion that transfers the image developed in the developing portion on the image carrier onto a surface of a recording medium; and
a recording medium transporting portion that transports the surface of the recording medium onto which the image has been transferred facing vertically downward with an opposite surface of the recording medium being sucked and held by air flow from the recording medium transporting portion.

2. An image forming apparatus according to claim 1, wherein the carrier liquid is nonvolatile oil.

3. An image forming apparatus according to claim 1, further comprising a fixing portion that fixes the recording medium transported by the recording medium transporting portion.

4. An image forming apparatus according to claim 1, wherein the recording medium transporting portion includes a transporting belt having an air flow hole that allows air to flow therethrough.

5. An image forming apparatus according to claim 1, wherein the transfer portion includes a transfer roller serving as a recording medium gripping member that grips the recording medium.

6. An image forming method comprising:
developing an image on a latent image carrier by using a liquid developer including a toner and a carrier liquid;
transferring the image developed on the latent image carrier to a surface of a recording medium;
transporting the recording medium onto which the image has been transferred, with the surface of the recording medium onto which the image has been transferred facing vertically downward, with an air flow holding an opposite surface of the recording medium; and
fixing the transferred image on the recording medium.

7. An image forming apparatus comprising:
a developing portion that develops an image on an image carrier with a liquid developer including a toner and a carrier liquid;
a transfer portion that transfers the image developed in the developing portion on the image carrier onto a surface of a recording medium;
a recording medium transporting portion that transports the surface of the recording medium onto which the image has been transferred facing vertically downward with an opposite surface of the recording medium being sucked and held by air flow from the recording medium transporting portion; and
a fixing portion that fixes the recording medium transported by the recording medium transporting portion,
wherein the transfer portion includes a transfer roller serving as a recording medium gripping member that grips the recording medium.
